(19) United States
(12) Patent Application Publication
(10) Pub. No.: US 2020/0010033 A1
(43) Pub. Date: Jan. 9, 2020

(54) PROTECTIVE MEMBER, VEHICULAR HIGH-VOLTAGE WIRE, AND WIRE HARNESS

(71) Applicant: SUMITOMO WIRING SYSTEMS, LTD., Yokkaichi-shi, Mie (JP)

(72) Inventor: Masahiro HAGI, Yokkaichi-shi (JP)

(73) Assignee: SUMITOMO WIRING SYSTEMS, LTD., Yokkaichi-shi, Mie (JP)

(21) Appl. No.: 16/480,495

(22) PCT Filed: Feb. 9, 2018
(86) PCT No.: PCT/JP2018/004710

§ 371 Date: Jul. 24, 2019

(30) Foreign Application Priority Data
Feb. 13, 2017 (JP) 2017-024119

(51) Int. Cl. B60R 16/02; H01B 7/00; H01B 7/18; H02G 3/04

(52) U.S. Cl. CPC B60R 16/0215; H02G 3/04; H01B 7/18; H01B 7/0045

(57) ABSTRACT

A tubular protective member that includes a plurality of strands that are weaved together and that cover a core wire made of a conductor, the plurality of strands including: a first strand formed of a reinforced fiber that is insulating; and a second strand configured to be visually distinguishable from the first strand.

This application is the U.S. National Phase of PCT/JP2018/004710 filed Feb. 9, 2018, which claims priority to JP 2017-024119 filed Feb. 13, 2017, the entire disclosure of which is incorporated herein by reference.

### BACKGROUND

The present disclosure relates to a protective member, a vehicular high-voltage wire, and a wire harness.

Conventionally, as shown in JP 2016-63557A for example, a vehicle such as a hybrid car or an electric automobile includes a motor serving as a power source for propelling the vehicle, an inverter connected to the motor, and a high-voltage battery that supplies electrical power to the inverter. The inverter and the high-voltage battery are connected to each other by a wire harness that includes two high-voltage wires, namely a positive and a negative high-voltage wire.

### SUMMARY

Improvement of shock resistance at the time of vehicle collision or the like is desired for electric wires that are routed in the vehicle as mentioned above.

An exemplary aspect of the disclosure provides a protective member, a vehicular high-voltage wire, and a wire harness that can improve shock resistance.

A protective member that solves the foregoing issue includes a plurality of strands that are weaved together and that cover a core wire made of a conductor, the plurality of strands including: a first strand formed of a reinforced fiber that is insulating; and a second strand configured to be visually distinguishable from the first strand.

With this configuration, the shock resistance of the protective member can be improved by the first strand formed of reinforced fibers. Also, the second strand can be easily confirmed in the protective member formed by weaving the first strand and the second strand. In addition, it is easy to measure the helical pitch of the protective member through the confirmed second strand.

In the above protective member, it is preferable that the second strand is formed of the same reinforced fiber as the first strand, and is colored in a different color from the first strand.

With this configuration, the shock resistance of the protective member can be improved by forming the first and second strands using reinforced fibers. In addition, it is possible to visually confirm the second strand easily by making the color of the second strand different from the color of the first strand.

In the above protective member, it is preferable that the second strand is formed of metal.

With this configuration, a shielding property can be added to the protective member by the second strand formed of metal.

It is preferable that the above protective member is formed by weaving a plurality of first strand bundles including the first strand and one second strand bundle including the second strand.

With this configuration, in the protective member formed by weaving the plurality of first strand bundles and one second strand bundle, it is easy to measure the helical pitch of the protective member through the second strand included in the second strand bundle.

In the above protective member, it is preferable that the second strand is one of a plurality of identical strands forming the second strand bundle.

With this configuration, the second strand bundle formed of the plurality of second strands can be easily confirmed, and the helical pitch of the protective member can be easily measured.

A vehicular high-voltage wire that solves the foregoing issue is a vehicular high-voltage wire to be electrically connected to an in-vehicle high-voltage battery, the vehicular high-voltage wire including the core wire, which is formed of the conductor and is to be electrically connected to the high-voltage battery, an insulating covering, which covers an outer circumference of the core wire, and the protective member, which covers the outer circumference of the insulating covering, wherein the core wire, the insulating covering and the protective member are arranged coaxially.

With this configuration, the shock resistance of the protective member in the vehicular high-voltage wire can be improved. Also, the second strand of the protective member can be easily confirmed, and the helical pitch of the protective member can be easily measured through the second strand.

A wire harness that solves the foregoing issue includes the above-mentioned vehicular high-voltage wire.

With this configuration, the shock resistance of the protective member in the vehicular high-voltage wire of the wire harness can be improved. Also, the second strand of the protective member can be easily confirmed, and the helical pitch of the protective member can be easily measured through the second strand.

With the protective member, the vehicular high-voltage wire, and the wire harness according to the present invention, the shock resistance can be improved.

### BRIEF DESCRIPTION OF THE DRAWINGS

FIG. 1 is a schematic configuration diagram of a wire harness according to an embodiment.

FIG. 2 is a cross-sectional view of the wire harness.

FIG. 3A is a schematic configuration diagram of an electric wire, FIG. 3B is a schematic view showing a weaving structure of a protective member, and FIG. 3C is a side view schematically showing a helical structure of strands constituting the protective member.

FIG. 4 is a schematic view showing an example of formation of strand bundles and strands.

FIG. 5 is a schematic view showing an electric wire in variation.

FIG. 6 is a schematic view showing an electric wire in variation.

### DETAILED DESCRIPTION OF EMBODIMENTS

One embodiment will be described below.

Note, that portions of configurations may be shown in an exaggerated or simplified manner in the drawings in order to facilitate their description. The proportions of portions may also differ from actual proportions.

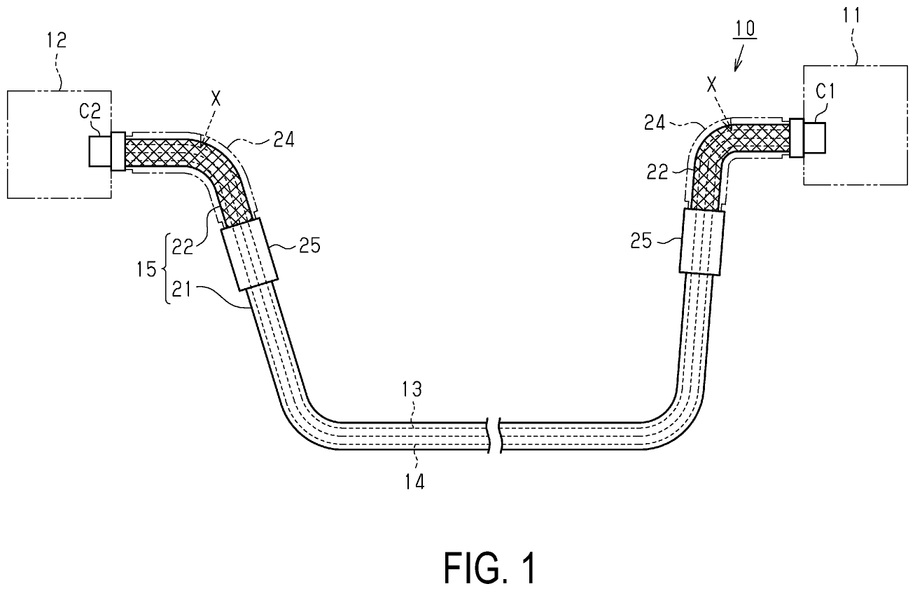

As shown in FIG. 1, in a vehicle such as a hybrid car or an electric automobile, a wire harness 10 of the present embodiment connects a high-voltage battery 11 installed at the rear of the vehicle and an inverter 12 installed at the front of the vehicle, for example. The wire harness 10 is routed, for example, under the floor or the like of the vehicle. The inverter 12 is connected to a wheel driving motor (not shown) serving as a power source for propelling the vehicle, generates AC (alternating current) power from DC (direct current) power of the high-voltage battery 11, and supplies the generated AC power to the motor. The high-voltage battery 11 is a battery that can supply a voltage of several hundred volts.

The wire harness 10 includes a positive high-voltage wire 13 and a negative high-voltage wire 14 respectively connected to a plus terminal and a minus terminal of the high-voltage battery 11, and a tubular electromagnetic shield portion 15 collectively surrounding the high-voltage wires 13 and 14. The high-voltage wires 13 and 14 are non-shielded electric wires having no shield structure, and are electric wires that can cope with a high voltage and a large current. The high-voltage wires 13 and 14 are inserted through the electromagnetic shield portion 15. One end portions of the high-voltage wires 13 and 14 are connected to the high-voltage battery 11 via a connector C1 and the other end portions are connected to the inverter 12 via a connector C2.

The electromagnetic shield portion 15 is formed into an elongated tubular shape as a whole. Then, the electromagnetic shield portion 15 is constituted by a metal pipe 21 at its intermediate portion in the length direction, and is constituted by a braided member 22 in the range including both end portions in the length direction other than the portion constituted by the metal pipe 21.

The metal pipe 21 is formed of, for example, an iron-based or an aluminum-based metal material. The metal pipe 21 is routed under the floor of the vehicle, and is bent in a predetermined shape depending on the structure under the floor. The metal pipe 21 collectively shields the high-voltage wires 13 and 14 inserted therethrough, and protects the high-voltage wires 13 and 14 from flying stones or the like.

The braided member 22 is a tubular member constituted by weaving a plurality of metal strands (bare wires). The braided members 22 are respectively connected to both end portions in the longitudinal direction of the metal pipe 21 by connecting members (not shown) such as crimping rings or the like, whereby the braided members 22 and the metal pipe 21 are electrically connected to each other. The outer circumference of each braided member 22 is surrounded by an external material 24 such as a corrugated tube. Also, rubber grommets 25 are attached to the connecting portions between the metal pipe 21 and the braided members 22 so as to cover the outer circumference of the connecting portions to prevent water from entering.

Braided members 22 collectively surround the outer circumference of portions (pipe exterior positions X) led out from the end portions of the metal pipe 21 in the high-voltage wires 13 and 14. As a result, the pipe exterior positions X of the high-voltage wires 13 and 14 are shielded by the braided members 22.

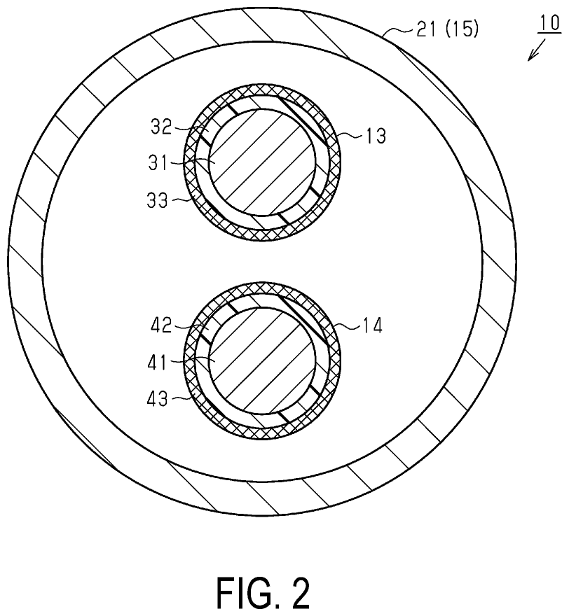

As shown in FIG. 2, the positive high-voltage wire 13 has a configuration in which a core wire 31, which is formed of a conductor, an insulating covering 32, which covers the outer circumference of the core wire 31, and a tubular protective member 33, which covers the outer circumference of the insulating covering 32, are arranged coaxially.

The insulating covering 32 is formed of a resin material. The insulating covering 32 is formed by extrusion covering the outer circumferential surface of the core wire 31, and is fitted tightly around the outer circumferential surface of the core wire 31. The protective member 33 has a tubular shape, and covers the outer circumference of the insulating covering 32. The protective member 33 is configured as a braided body in which a plurality of strands are woven, and has flexibility. Note, that the protective member 33 has a length substantially covering the entire length of the insulating covering 32. Also, both end portions of the protective member 33 are fixed to the insulating covering 32 by being wrapped with an adhesive tape.

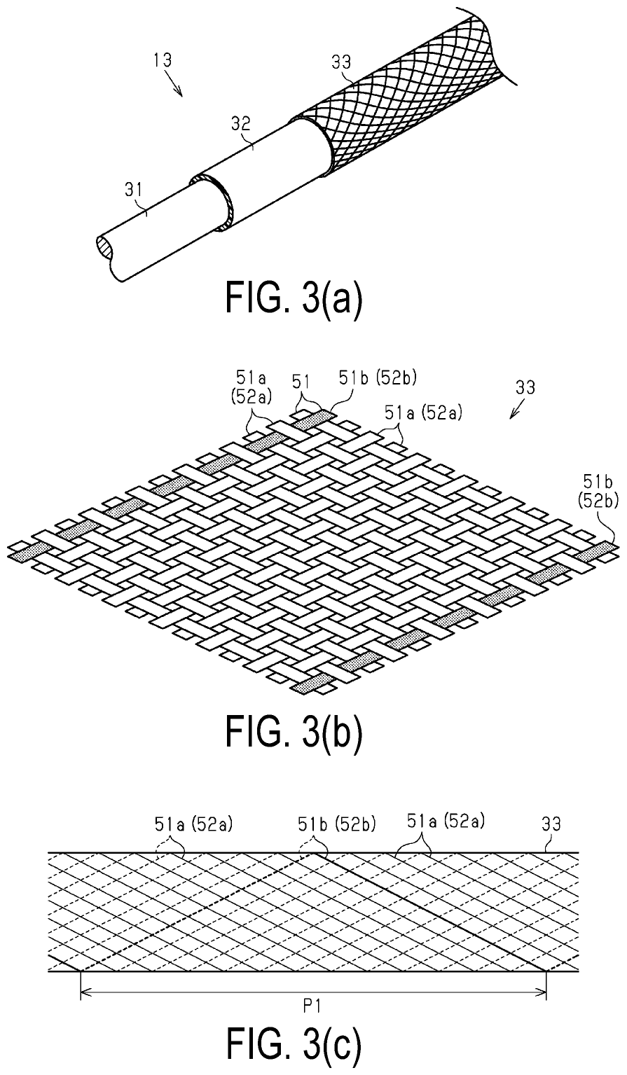

As shown in FIGS. 3A and 3B, the protective member 33 is constituted by weaving a plurality of strand bundles 51 (called picks) into a tubular shape. Each strand bundle 51 is constituted by a plurality of strands. In the present embodiment, the protective member 33 is constituted by, for example, 24 strand bundles 51, and each strand bundle 51 is constituted by three strands. That is to say, in the protective member 33 of the present embodiment, the number of strands is 3 and the number of strand bundles is 24.

As shown in FIG. 3B, the protective member 33 is constituted by 23 first strand bundles 51a and one second strand bundle 51b.

Each first strand bundle 51a is constituted by a plurality of (three) first strands 52a. In the present embodiment, the first strand 52a is formed of reinforced fibers excellent in insulating properties and shearing resistance.

The second strand bundle 51b is constituted by a plurality of (three) second strands 52b. In the present embodiment, the second strand 52b is formed of reinforced fibers excellent in insulating properties and shearing resistance.

Examples of the reinforced fibers include para-aramid fiber, polyarylate fiber, PBO (polyparaphenylene benzobisoxazole) fiber, PET (polyethylene terephthalate) fiber, ultrahigh molecular weight polyethylene fiber, PEI (polyether imide) fiber, glass fiber, and ceramic fiber. It is preferable that one or more of these types is used in accordance with the physical properties required of the protective member 33. The protective member 33 of the present embodiment is constituted by one of the above types, namely para-aramid fiber.

In the present embodiment, the first strand 52a constituting the first strand bundle 51a and the second strand 52b constituting the second strand bundle are configured to be visually distinguishable from each other. The first strand 52a and the second strand 52b are formed in different colors, for example. The first strand 52a is colored by dyeing or the like, for example, with respect to the second strand 52b.

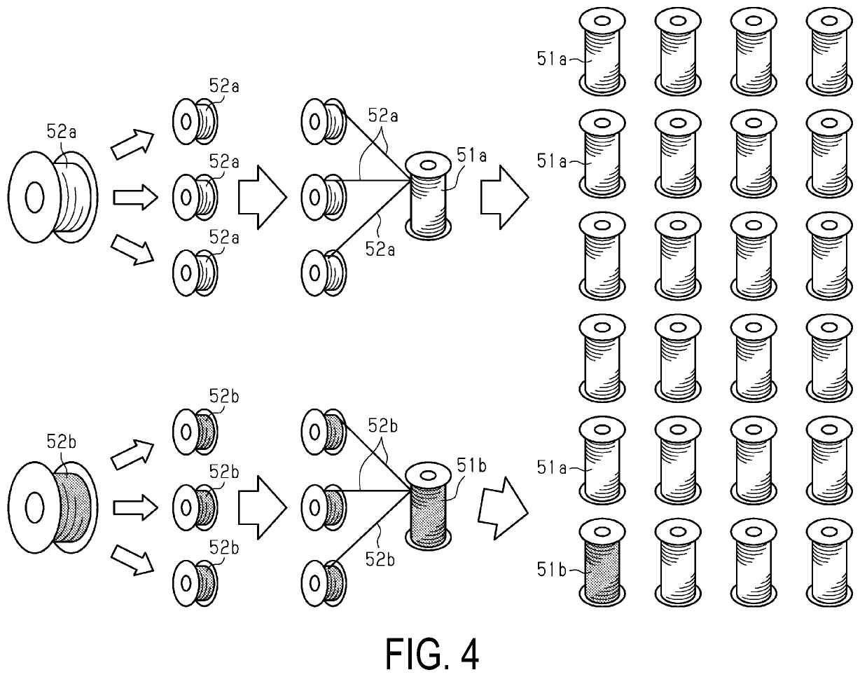

As shown in FIG. 4, for example, three bobbins around each of which the first strand 52a is wound are prepared. Then, a bobbin around which one set of first strand bundle (pick) 51a, formed by the first strands 52a from each bobbin being wound together, is wound is prepared. Twenty-three bobbins that are the same as this bobbin are used. Also, three bobbins around each of which the second strand 52b is wound are prepared. Then, a bobbin around which one set of second strand bundle (pick) 51b, formed by the second strands 52b from each bobbin being wound together, is wound is prepared. These bobbins are set in the weaving machine, and the protective member 33 shown in FIG. 3A is formed by weaving the first strand bundles 51a and the second strand bundle 51b.

As shown in FIG. 3C, the second strand bundle 51b (the second strands 52b) woven in the protective member 33 can be visually distinguished from the first strand bundles 51a (the first strands 52a). Accordingly, it is possible to visually recognize the woven position of the second strand bundle 51b (the second strands 52b), which is woven in the protective member 33, in a short time. In addition, it is easy to measure the helical pitch P1 of the first strand bundles 51a (the first strands 52a) and the second strand bundle 51b (the second strands 52b) constituting the protective member 33.

The helical pitch P1 of the protective member 33 affects the shock resistance of the protective member 33. The shock resistance of a protective member 33 whose helical pitch P1 is larger than the design value is lower than the shock resistance set at the design stage. In other words, with a protective member 33 having larger helical pitch than the design value, desired shock resistance cannot be obtained. Therefore, it is possible to ensure the shock resistance of the protective member 33 by measuring the helical pitch P1 of the protective member 33.

As shown in FIG. 2, similar to the positive high-voltage wire 13, the negative high-voltage wire 14 has a configuration in which a core wire 41, which is formed of a conductor, an insulating covering 42, which covers the outer circumference of the core wire 41, and a tubular protective member 43, which covers the outer circumference of the insulating covering 42, are arranged coaxially. The configurations of the core wire 41, the insulating covering 42, and the protective member 43 of the negative high-voltage wire 14 are the same as those of the core wire 31, the insulating covering 32, and the protective member 33 of the positive high-voltage wire 13 respectively, and thus the detailed description thereof will be omitted.

Next, the operative effect of the present embodiment will be described.

The positive high-voltage wire 13 has a configuration in which the core wire 31 and the insulating covering 32 are covered with the protective member 33, which is woven with reinforced fibers formed of, for example, para-aramid fibers and is excellent in shock resistance (particularly, shear resistance). Similarly, the negative high-voltage wire 14 has a configuration in which the core wire 41 and the insulating covering 42 are covered with the protective member 43, which is woven with reinforced fibers formed of, for example, para-aramid fibers and is excellent in shock resistance (particularly, shear resistance). Accordingly, even if the metal pipe 21 is damaged by shock at the time of a vehicle collision, direct contact between the core wires 31 and 41 of the positive high-voltage wire 13 and the negative high-voltage wire 14 is suppressed, or conduction through a broken piece of the metal pipe 21 or some other conductors such as vehicle components other than the broken piece is suppressed. Also, the protective member 33 has insulating properties, and thus conduction between the core wires 31 and 41 of the positive high-voltage wire 13 and the negative high-voltage wire 14 through the protective member 33 is suppressed.

The protective member 33 is constituted by 23 first strand bundles 51a and one second strand bundle 51b. Each first strand bundle 51a is constituted by three first strands 52a, and the second strand bundle 51b is constituted by three second strands 52b. The colors of the first strand 52a and the second strand 52b are different from each other. Accordingly, the second strand 52b is visually distinguishable from the first strand 52a. For this reason, it is possible to visually recognize the woven position of the second strand bundle 51b (the second strands 52b), which is woven in the protective member 33, in a short time. In addition, it is easy to measure the helical pitch P1 of the first strand bundles 51a (the first strands 52a) and the second strand bundle 51b (the second strands 52b) constituting the protective member 33.

As mentioned above, according to the present embodiment, the following advantageous effects can be obtained.

(1) Each of the protective members 33 and 34 of the high-voltage wires 13 and 14 are constituted by 23 first strand bundles 51a each including the first strand and one second strand bundle 51b including the second strand 52b. The first strand 52a and the second strand 52b are formed of reinforced fibers having insulating properties with high strength. Accordingly, the shock resistance of the protective members 33 and 43 and the wire harness 10 can be improved.

(2) The protective member 33 is constituted by 23 first strand bundles 51a each including the first strand 52a and one second strand bundle 51b including the second strand 52b. The colors of the first strand 52a and the second strand 52b are different from each other. Accordingly, the second strand 52b is visually distinguishable from the first strand 52a. For this reason, it is easy to visually recognize the woven position of the second strand bundle 51b (the second strands 52b) that is woven in the protective member 33. In addition, it is easy to measure the helical pitch P1 of the first strand bundles 51a (the first strands 52a) and the second strand bundle 51b (the second strands 52b) constituting the protective member 33 in a short time.

(3) The second strand bundle is formed of three second strands 52b. Thus, the second strand bundle 51b of the protective member 33 can be easily visually recognized. As a result, the helical pitch P1 of the protective member 33 can be easily measured in a short time.

The embodiment described above may also be carried out in the following manner. Note, that the same reference numerals are given to the same members as those in the above embodiment, and a part or all of the explanation will be omitted.
In the above embodiment, the protective member 43 of the negative high-voltage wire 14 may also be omitted.
In the above embodiment, the configuration of the wire harness may also be changed as appropriate.

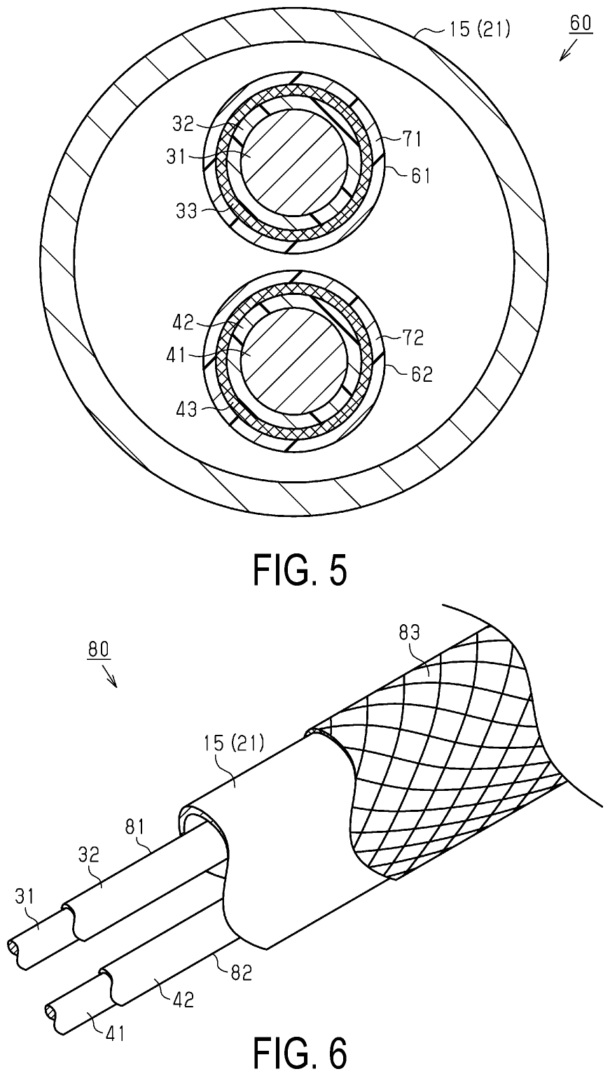

A wire harness 60 shown in FIG. 5 includes a positive high-voltage wire 61 and a negative high-voltage wire 62 respectively connected to the plus terminal and the minus terminal of the high-voltage battery, and the electromagnetic shield portion 15 that collectively surrounds the high-voltage wires 61 and 62. The electromagnetic shield portion 15 is constituted by the metal pipe 21 shown in FIG. 5 and the braided member 22 (not shown).

The positive high-voltage wire 61 has a configuration in which the core wire 31, which is formed of a conductor, the insulating covering 32, which covers the outer circumference of the core wire 31, the tubular protective member 33, which covers the outer circumference of the insulating covering 32, and a protective tube 71, which is formed of resin and surrounds the outer circumference of the protective member 33, are arranged coaxially. The protective tube 71 is formed of, for example, a resin material such as polyethylene and has a tubular shape. The protective tube 71 is locally provided in the longitudinal direction of the positive high-voltage wire 61. In the wire harness 10 shown in FIG. 1, the protective tubes 71 are provided at portions passing through the braided members 22 in the positive high-voltage wire 13.

Similar to the positive high-voltage wire 61, the negative high-voltage wire 62 has a configuration in which the core wire 41, which is formed of a conductor, the insulating covering 42, which covers the outer circumference of the core wire 41, the tubular protective member 43, which covers the outer circumference of the insulating covering 42, and a protective tube 72, which is formed of resin and surrounds the outer circumference of the protective member 43, are arranged coaxially.

Note, that in FIG. 5, the protective tube 72 may also be omitted. Also, the protective tube 72 and the protective member 43 may also be omitted.

A wire harness 80 shown in FIG. 6 includes a positive high-voltage wire 81 and a negative high-voltage wire 82 respectively connected to the plus terminal and the minus terminal of the high-voltage battery, the electromagnetic shield portion 15 that collectively surrounds the high-voltage wires 81 and 82, and a protective member 83 that protects the metal pipe 21 constituting a part of the electromagnetic shield portion 15. The high-voltage wires 81 and 82 are covered electric wires in which the core wires 31 and 41 formed of a conductor are respectively covered with insulating coverings 32 and 42. Also, the high-voltage wires 81 and 82 are non-shielded electric wires having no shield structure, and are electric wires that can cope with a high voltage and a large current.

Similar to the protective members 33 and 43 of the above embodiment, the protective member 83 is formed by weaving the first strand bundles 51a (the first strands 52a) and the second strand bundle 51b (the second strands 52b) shown in FIG. 3B. Similar to the protective members described in the above embodiment, the helical pitch of such a protective member 83 can be easily measured.
In the above embodiment, the first strand bundle 51a (the first strands 52a) and the second strand bundle 51b (the second strands 52b) are formed of the same material (reinforced fibers), but the first strand and the second strand may also be formed of different materials. In the above embodiment, for example, the first strand 52a and the second strand 52b are formed of para-aramid fibers, but one of the strands may also be formed of reinforced fibers other than para-aramid fibers (e.g., polyarylate fibers). Also, the second strand 52b may also be formed of metal such as copper and aluminum. Through the changed material, the first strand 52a and the second strand 52b can be visually distinguished from each other. The first strand 52a and the second strand 52b can be distinguished from each other, for example, due to the difference between colors or the states of the surfaces (such as reflection of light due to their roughness), and it is easy to measure the helical pitch. In addition, by the second strand 52b being formed of metal, a shielding function can be added.
In the above embodiment, the first strand bundle 51a (the first strands 52a) and the second strand bundle 51b (the second strands 52b) can be visually distinguished from each other by coloring by dyeing or the like, but they may also be distinguished, for example, by changing the color by coating with paint of a desired color. Also, using a fluorescent material or the like, they may be also be distinguished from each other by irradiation with light having a predetermined wavelength (e.g., ultraviolet rays).
The number of the second strand bundle 51b constituting each of the protective members 33 and 43 is not necessarily one. Each of the protective members 33 and 43 may also be constituted by a plurality of second strand bundles. Also, the protective member may also be constituted by the first strand bundle 51a (the first strands 52a) and the second strand bundle 51b (the second strands 52b), and a strand bundle (strands) that can be visually distinguished from them (for example, a strand bundle having a different color).
In the above embodiment, the second strand bundle 51b is constituted by three second strands 52b, but the second strand bundle may also include at least one second strand 52b. In other words, the number of the second strands 52b constituting the second strand bundle 51b is not necessarily three.
In the protective members 33 and 43 of the above embodiment, the number of the strands and the number of the strand bundles may also be changed as appropriate.
The above-described embodiment and variations may also be combined as appropriate.

It will be apparent to those skilled in the art that the present disclosure may also be embodied in other specific forms without departing from the technical concept of the invention. The components described in the above embodiment (or one or more aspects thereof) may also be partly omitted or combined, for example.

1. A tubular protective member comprising:
a plurality of strands that are weaved together and that cover a core wire made of a conductor,
the plurality of strands including:
a first strand formed of a reinforced fiber that is insulating; and
a second strand configured to be visually distinguishable from the first strand.

2. The protective member according to claim 1, wherein
the second strand is formed of a same reinforced fiber as the first strand, and is colored in a different color from the first strand.

3. The protective member according to claim 1, wherein
the second strand is formed of metal.

4. The protective member according to claim 1, wherein
the protective member is formed by weaving a plurality of first strand bundles including the first strand and one second strand bundle including the second strand.

5. The protective member according to claim 4, wherein
the second strand is one of a plurality of identical strands forming the second strand bundle.

6. A vehicular high-voltage wire to be electrically connected to an in-vehicle high-voltage battery, the vehicular high-voltage wire comprising:
the core wire, which is formed of the conductor and is to be electrically connected to the high-voltage battery,
an insulating covering, which covers an outer circumference of the core wire, and
the protective member according to claim 1, which covers an outer circumference of the insulating covering,
wherein the core wire, the insulating covering and the protective member are arranged coaxially.

7. A wire harness comprising the vehicular high-voltage wire according to claim 6.
